(19) United States
(12) Patent Application Publication
(10) Pub. No.: US 2006/0285666 A1
(43) Pub. Date: Dec. 21, 2006

(54) Network support for subscriber-defined threshold for unknown caller-ID call completion

(75) Inventors: David S. Benco, Winfield, IL (US); Sanjeev Mahajan, Naperville, IL (US); Baoling S. Sheen, Naperville, IL (US); Sandra Lynn True, St. Charles, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/140,870

(22) Filed: May 31, 2005

(51) Int. Cl. H04M 15/06

(52) U.S. Cl. 379/142.01

(57) ABSTRACT

A method of supporting a call rejection feature is provided in a telecommunications network (30). The method includes: receiving at a facility (20) of the telecommunications network (30), a call from a calling party, the call being for a called party served by the facility (20); determining for the received call if caller ID information for the calling party is available to be provided to the called party; if the calling party's caller ID information is available to be provided to the called party, then connecting the call to the called party, otherwise if the calling party's caller ID information is not available to be provided to the called party, then providing the calling party with an option to connect the call to the called party; and, connecting the call to the called party if the calling party exercises the option, otherwise not connecting the call to the called party if the calling party does not exercise the option.

### FIELD

The present inventive subject matter relates to the telecommunication arts. Particular application is found in conjunction with certain types of telecommunication networks, and the specification makes particular reference thereto. However, it is to be appreciated that aspects of the present inventive subject matter are also amenable to other like applications and/or networks.

### BACKGROUND

In telecommunications networks, the caller ID function or service is generally well known. Typically, when a call is placed by a calling party to a called party, e.g., over a public switched telephone network (PSTN), if the called party subscribes to the caller ID feature or service, then the called party is provided with the telephone number or other identifying information for the calling party. For example, the telephone number or name of the calling party may be output on a display associated with the called party's telephone or other end user terminal when it rings or is otherwise alerted of the incoming call. Accordingly, the called party is given-the opportunity to determine who is calling before they chose whether or not to answer the call.

However, a calling party may opt to block their telephone number or other identifying information from being revealed to the called party by the caller ID service. In general, caller ID blocking is a well known feature. For example, a calling party may elect to have their caller ID information blocked for all outgoing calls (i.e., complete caller ID blocking) or may chose to block it on a per call basis, e.g., by dialing a feature code prior to dialing the telephone number they are calling (i.e., selective caller ID blocking). In either case, when the calling party has blocked their caller ID information for an outgoing call they have placed, then the called party (even though they subscribe to the caller ID service) is not provided with the calling party's telephone number or other identifying information. Rather, the called party is provided with an indication that the calling party's information or telephone number is blocked or withheld or restricted or private or anonymous or unknown or otherwise unavailable.

Telemarketers and the like have been known to use the caller ID blocking feature when making telemarketing calls, e.g., to mask or hide their true identity from called parties that may otherwise avoid taking such calls if they knew from where or whom the calls were originating. For this reason and/or others, many caller ID subscribers simply do not want the intrusion of calls when the calling party's caller ID information is not available. Accordingly, there has been developed what is known as an anonymous call rejection (ACR) feature or service. Typically, when the ACR service or feature is subscribed to by a party, calls directed to that party are rejected or blocked (e.g., so that the called party's telephone or end user terminal does not ring or is not otherwise alerted) if the calling party's caller ID information (e.g., name and/or telephone number) is unavailable or otherwise cannot be provided to the called party.

While generally acceptable, the conventional ACR service feature has certain limitations. That is to say, instances may occur where a subscriber to the ACR service feature may desire to receive a call that would otherwise be blocked or rejected by the ACR service feature. For example, the subscriber may be willing to accept calls from telemarketers that block their caller ID information provided that the subscriber was sufficiently compensated for their time and/or effort. In another case, the calling party may not be a telemarketer at all, but merely someone whose caller ID information is unavailable, someone the subscriber would otherwise be willing to accept a call from. For example, the calling party may be a friend, acquaintance or relative of the subscriber, and when they called the subscriber their caller ID information was unintentionally blocked (e.g., this might happen if the calling party has the complete caller ID blocking feature enabled and they forget to or do not know how to disable it). In still some other circumstances, caller ID information may be unavailable other than as a result of intentional withhold or blocking, in which case, the subscriber may be willing to accept some of these calls. In any event, short of deactivating the feature, a conventional ACR service feature typically cannot adequately accommodate such situations, and deactivating the feature may allow certain other calls through that the subscriber still wishes to block or reject.

Accordingly, a new and improved ACR service and/or feature is disclosed that overcomes the above-referenced problems and others.

### SUMMARY

In accordance with one embodiment, a method of supporting a call rejection feature is provided in a telecommunications network. The method includes: receiving at a facility of the telecommunications network, a call from a calling party, the call being for a called party served by the facility; determining for the received call if caller ID information for the calling party is available to be provided to the called party; if the calling party's caller ID information is available to be provided to the called party, then connecting the call to the called party, otherwise if the calling party's caller ID information is not available to be provided to the called party, then providing the calling party with an option to connect the call to the called party; and, connecting the call to the called party if the calling party exercises the option, otherwise not connecting the call to the called party if the calling party does not exercise the option.

In accordance with another embodiment, a system for supporting a call rejection service in a telecommunications network includes: a facility serving a terminal of a first party and operatively connected to the telecommunications network, the facility receiving a call from a second party for the first party; and, determination means that determines for the call received by the facility if caller ID information for the second party is available to be provided to the first party. If the second party's caller ID information is available to be provided to the first party, then the call is connected by the facility to the first party's terminal, otherwise if the second party's caller ID information is not available to be provided to the first party, then the second party it prompted by the facility to selectively choose an option to connect the call to the first party, the-facility connecting the call to the first party if the second party chooses the option, otherwise the facility does not connect the call to the first party if the second party does not choose the option.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary telecommunications network suitable for practicing aspects of the present inventive subject matter.

FIG. 2 is a flow chart showing an exemplary ACR process embodying aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications art without further detailed explanation as to their configuration or operation except to the extent they have been modified or altered in accordance with and/or to accommodate the preferred embodiment(s) presented herein.

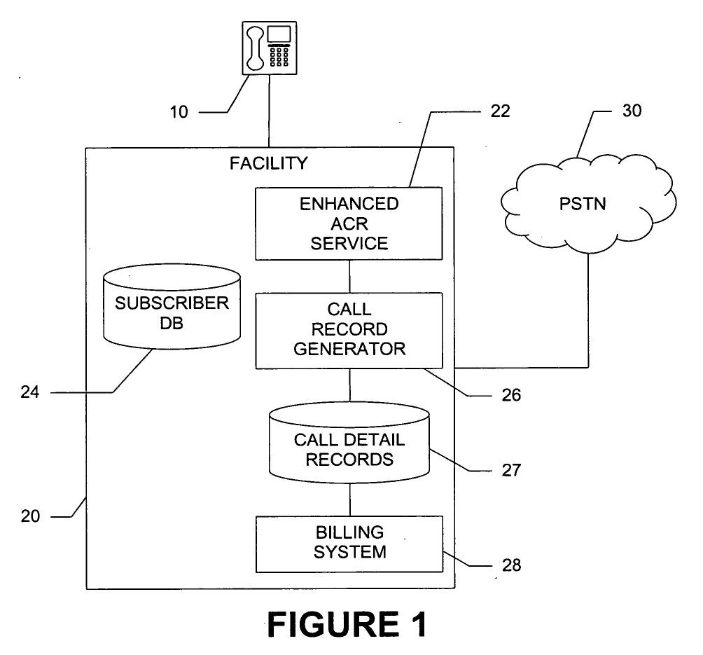

With reference to FIG. 1, a user or subscriber uses an end user terminal 10 to selectively place and/or receive telephone calls over a telecommunications network. Suitably, the terminal 10 is served by a telecommunications facility 20 that is operatively connected to and/or in communication with a public switched telephone network (PSTN) 30 in the usual manner. As shown, the facility 20 is equipped with and/or otherwise has access to an enhanced ACR service 22, a subscriber database (DB) 24, a call record generator 26 and a billing system 28. While for simplicity and clarity herein only one terminal 10 and facility 20 are illustrated in the present example, it is to be appreciated that a single facility 20 suitably serves a plurality of similarly situated terminals and that a plurality of such facilities are similarly equipped and/or likewise arranged with respect to the PSTN 30.

For example, in a landline or wireline application, the terminal 10 is optionally a landline telephone or other like end user telecommunication device or landline customer premises equipment (CPE), and the facility 20 serving the terminal 10 is an end office (EO) that is operatively connected to the PSTN 30 in the usual manner. Suitably, the EO includes a telecommunications switch (e.g., a class 5 switch such as the 5ESS or another like switch) to which the terminal 10 is operatively connected in the usual manner, e.g., via a twisted-pair landline cable or the like. In the landline or wireline embodiment, the CDR generator 26 is suitably an automatic message accounting (AMA) system or the like.

In a wireless or mobile application, e.g., the facility 20 serving the terminal 10 is a mobile switching center (MSC) operatively connected to and/or in communication with the PSTN 30 in the usual manner. Suitably, the MSC is also operatively connected to and/or in communication with a plurality of base stations (not shown) in the usual manner. As is understood in the art, each base station (BS) provides an over-the-air radio frequency interface for its respective geographic area or cell. Selectively, the terminal 10 (which in this embodiment is a mobile or wireless telephone or other appropriate mobile station (MS)) is provided telecommunication services and/or otherwise accesses the network via the interface and/or the BS serving the cell in which the MS is located. In the wireless or mobile embodiment, the call record generator 26 is suitably a call detail recording (CDR) system or the like.

In the normal course of processing, connecting and/or otherwise handling calls to and/or from the terminal 10, the facility 20 employs the call record generator 26 (be it an CDR system, an AMA system or another like system) in the usual manner to produce a typical call detail record (CDR) and/or other like record for each call. The generated CDRs or other records are normally stored for a period of time, e.g., in the call record DB 27. Suitably, as is known in the art, the records are periodically collected from the call record DB 27 and delivery to a billing system 28 were they are used for billing and/or accounting purposes by a telephone company or telecommunications service provider operating the facility 20. A CDR or other like record produced by the call record generator 26 and/or stored in the call record DB 27 optionally includes such information as: a calling party or call origination identifier, e.g., the telephone number of the calling party or originating terminal, a called party or call termination identifier, e.g., the telephone number of the called party or terminating terminal, a start time of the call, an end time of the call, a duration of the call, etc. Optionally, other information may also be included in the record depending on the type of call, the record generating system employed, the type of facility producing the record, etc. This additional information may include, e.g., the quality of service for the call, signal strength, the cell used, the identity of the terminating and/or originating switch, etc.

Assuming a called party (e.g., using the terminal 10) subscribes to an enhanced ACR feature, then during the course of processing and/or otherwise handling calls placed or directed to the terminal 10, the facility 20 employs the enhanced ACR service 22 to selectively connect or not connect (i.e., reject or block) calls to the terminal 10. As desired by the user or subscriber or as otherwise selected, the terminal 10 (or its user) may or may not have a subscription to or otherwise have activated the enhanced ACR feature. For example, the subscriber DB 24 optionally has a list stored therein, and/or otherwise maintains data or information that indicates, which terminals and/or users (e.g., identified by their telephone numbers or other like identifiers) served by the facility 20 do and/or do not subscribe to and/or have activated the enhanced ACR feature. Suitably, the subscriber and/or activation status for the terminal 10 is so listed or indicated in the subscriber DB 24.

In operation, the enhanced ACR service 22 functions as any conventional ACR service, but the enhanced ACR service 22 additionally provides a calling party trying to connect with a subscriber (i.e., with the terminal 10) the option of overriding a call rejection which would otherwise occur when the calling party's caller ID information is unavailable or otherwise cannot be provided to the subscriber (i.e., the called party). Suitably, to select the override option, the calling party agrees to accept and/or pay a surcharge or fee that is in turn credited to the called party. Accordingly, if a call is placed by a calling party that would otherwise be blocked or rejected (i.e., not connected by the facility 20 to the called party's terminal 10) because the enhanced ACR service 22 is enabled or invoked and the calling party's caller ID information is unavailable, and if the calling party opts to override the rejection (i.e., agrees to accept the surcharge or fee), then the call is connected to the called party's terminal 10. Otherwise, if the calling party does not agree to accept the surcharge or fee, then the call is not connected by the facility 20 to the called party's terminal 10. That is to say, the call is dropped, blocked or otherwise rejected so that the terminal 10 does not ring or is not otherwise alerted. Optionally, the surcharge or fee is assessed and/or credited upon making the connection to the called party's terminal 10, or alternately, upon the called party answering the call.

It is to be appreciated that even when the enhanced ACR service 22 is enabled or invoked, if the calling party's caller ID information is available to be provided to the called party (i.e., the subscriber), then the call is connected to the called party's terminal 10 in the normal fashion. Moreover, insomuch as the override option was not used to avoid rejection or blocking of the call by the enhanced ACR service 22, no surcharge or fee is assessed from the calling party or credited to the called party.

Suitably, usage of the override option and/or acceptance of the surcharge or fee by the calling party is noted by the call record generator 26, e.g., via a communication from the enhanced ACR service 22. Accordingly, the CDR or other like record created or produced by the call record generator 26 includes this information. Then, when the CDRs are collected from the call record DB 27 and processed by the bill system 28, the surcharges or fees are billed to the calling parties that have exercised or used the override option, and the respective subscribers' bills are credited accordingly. Optionally, the amount or cost of the surcharge or fee is set or selected by each individual subscriber. For example, this amount is stored in the subscriber DB 24 along with their other subscription information. Optionally, the billing system 28 queries or accesses the subscriber DB 24 to determine how much to bill and/or credit the respective parties for each use of the override option. Alternately, the amount of the surcharge or fee is obtained from the subscriber DB 24 by the call record generator 22 at the time the CDR is produced and the obtained amount is then included in the CDR.

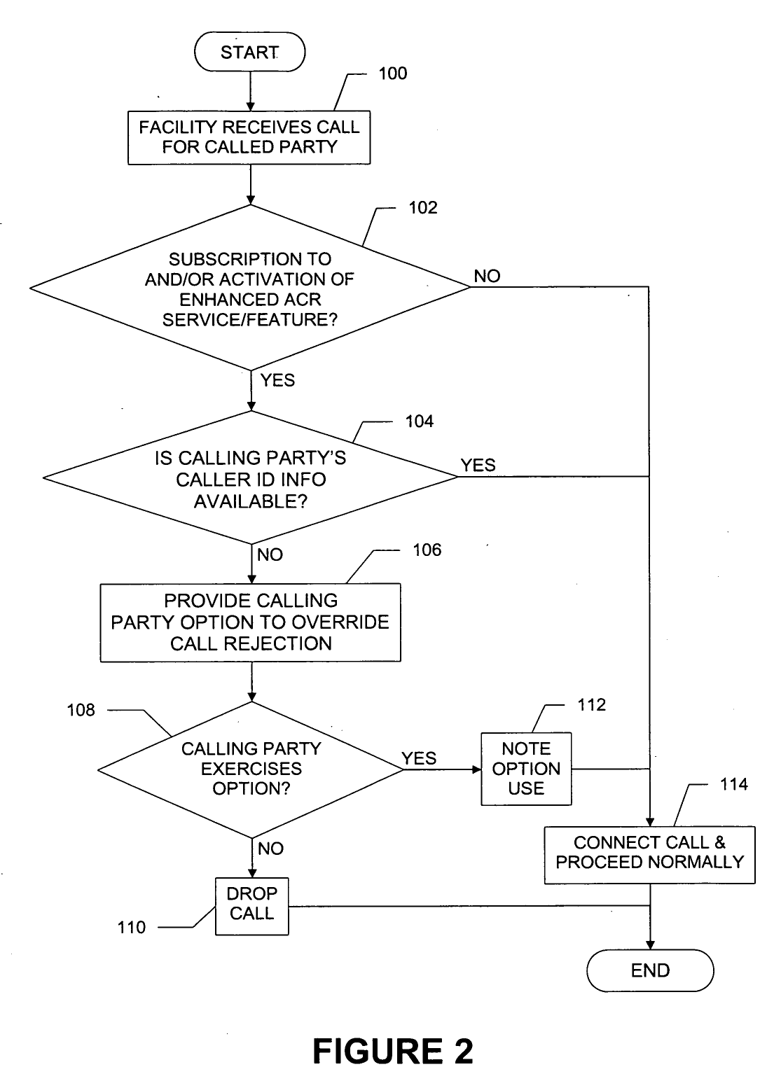

With reference to FIG. 2, an exemplary process illustrating the operation of the enhanced ACR service 22 will now be described. The process starts at step 100 with the facility 20 receiving a call from a calling party, the received call being directed to a called party server by the facility 20. For purposes of this example, we shall assume the called party uses the terminal 10 served by the facility 20 to receive calls.

At decision step 102, the facility 20 determines if the call received in step 100 is for a terminal or called party that has a subscription to and/or activation of the enhanced ACR feature. For example, the subscriber DB 24 is optionally queried or otherwise accessed to obtain the pertinent subscription status and/or activation information for the terminal 10 and/or the called party. If at decision step 102, it is determined that the called party is not a subscriber and/or the enhanced ACR feature is not activated for the terminal 10, then the enhanced ACR feature service 22 is disabled or otherwise not invoked for the call. Accordingly, at step 114, the call is connected by the facility 20 to the terminal 10 in the usual manner and it otherwise proceeds normally. Alternately, if at decision step 102, it is determined that the called party is a subscriber and the enhanced ACR feature is activated for the terminal 10, then the enhanced ACR service 22 is enabled and/or invoked.

Having been invoked, at decision step 104, the enhanced ACR service 22 determines if the calling party's caller ID information is available to be provided to the called party. If the calling party's caller ID information is available, then the enhanced ACR service 22 allows the call to be connected to the terminal 10 in the usual manner by the facility 20 so that the call may proceed normally as indicated at step 114. Otherwise, if the calling party's caller ID information is unavailable, then the process continues to step 106.

At step 106, the enhanced ACR service 22 provides the calling party with an override option to avoid blocking or rejection of the call. Suitably, the calling party is prompted to select a desired action from one or more choices. For example, the calling party is instructed (audibly or otherwise) to press or dial a number corresponding to their desired selection. Alternately, via an optional voice recognition capability, the calling party is able to verbalize their selection. Optionally, one selection chooses the override option and/or another selection declines the override option. Suitably, the surcharge or fee amount for exercising the override option is also provided to the calling party, e.g., by the enhanced ACR service 22 obtaining the same from the subscriber DB 24. A suitable announcement played to the calling party for example might be “please press or say one to accept a surcharge of ______ and continue this call, or please press or say two to decline the surcharge and discontinue this call.” Of course, the blank would be filled in with the appropriate amount for the particular instance.

At decision step 108, if the calling party does not exercise the override option or declines to accept the surcharge, then the enhanced ACR service 22 causes the call to be dropped, blocked or otherwise rejected, as indicated by step 110. That is to say, the call is not connected by the facility 20 to the called party's terminal 10. Accordingly, the called party is not disturbed by the call insomuch as the terminal 10 does not ring or is not otherwise alerted. Alternately, if the calling party does exercise the override option and accepts the surcharge, then the enhanced ACR service 22 communicates this information to the call record generator 24 so it can be appropriately noted in the CDR produced for the call, as indicated by step 112.

Having exercised the override option, the process continues from step 112 to step 114 where the call is connected to the terminal 10 in the usual manner by the facility 20 so that the call may proceed normally. Additionally, having been noted in the CDR, the billing system 28 (upon processing the CDR) will assess the surcharge and/or credit the respective parties accordingly.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of supporting a call rejection feature in a telecommunications network, said method comprising:
(a) receiving at a facility of the telecommunications network, a call from a calling party, said call being for a called party served by the facility;
(b) determining for the received call if caller ID information for the calling party is available to be provided to the called party;
(c) if the calling party's caller ID information is available to be provided to the called party, then connecting the call to the called party, otherwise if the calling party's caller ID information is not available to be provided to the called party, then-providing the calling party with an option to connect the call to the called party; and,
(d) connecting the call to the called party if the calling party exercises the option, otherwise not connecting the call to the called party if the calling party does not exercise the option.

2. The method of claim 1, further comprising:
assessing a surcharge of against the calling party in response to the calling party exercising the option, said surcharge being a selected amount.

3. The method of claim 2, wherein the amount for the surcharge is selected by the called party.

4. The method of claim 2, further comprising:
crediting the amount of the surcharge to the called party.

5. The method of claim 2, wherein the surcharge is not assessed if the called party does not answer the call.

6. The method of claim 1, further comprising:
noting if the option is exercised by the calling party in a call detail record.

7. The method of claim 1, wherein to exercise the option the calling party agrees to accept a surcharge prior to the call being connected to the called party.

8. The method of claim 1, wherein the telecommunications network is a public switched telephone network.

9. The method of claim 8, wherein the facility is an end office.

10. The method of claim 8, wherein the facility is a mobile switching center.

11. The method of claim 1, further comprising:
determining if the called party subscribes to the call rejection feature; and,
omitting steps (b) through (d) if it is determined that the called party does not subscribe to the call rejection feature.

12. A system for supporting a call rejection service in a telecommunications network, said system comprising:
a facility serving a terminal of a first party and operatively connected to the telecommunications network, said facility receiving a call from a second party for the first party; and,
determination means that determines for the call received by the facility if caller ID information for the second party is available to be provided to the first party;
wherein if the second party's caller ID information is available to be provided to the first party, then the call is connected by the facility to the first party's terminal, otherwise if the second party's caller ID information is not available to be provided to the first party, then the second party it prompted by the facility to selectively choose an option to connect the call to the first party, said facility connecting the call to the first party if the second party chooses the option, otherwise the facility does not connect the call to the first party if the second party does not choose the option.

13. The system of claim 12, further comprising:
means for assessing a surcharge of against the second party in response to the second party choosing the option, said surcharge being a selected amount.

14. The system of claim 13, wherein the amount for the surcharge is selected by the called party.

15. The system of claim 13, further comprising:
means for crediting the amount of the surcharge to the first party.

16. The system of claim 13, wherein the surcharge is not assessed if the first party does not answer the call.

17. The system of claim 12, further comprising:
means for noting in a call detail record if the option is chosen by the second party.

18. The system of claim 12, wherein to choose the option the second party agrees to accept a surcharge prior to the call being connected to the first party.

19. The system of claim 12, wherein the facility is an end office or a mobile switching station.

20. The system of claim 12, further comprising:
means for determining if the first party subscribes to the call rejection service.
